(19) United States
(12) Patent Application Publication
(10) Pub. No.: US 2013/0035862 A1
(43) Pub. Date: Feb. 7, 2013

(54) METHOD AND APPARATUS FOR CORRECTING TEMPERATURE EFFECTS FOR AZIMUTHAL DIRECTIONAL RESISTIVITY TOOLS

(71) Applicants: Sheng Fang, Houston, TX (US); Jack Signorelli, Cypress, TX (US); Zhiqiang Zhou, Houston, TX (US)

(72) Inventors: Sheng Fang, Houston, TX (US); Jack Signorelli, Cypress, TX (US); Zhiqiang Zhou, Houston, TX (US)

(73) Assignee: BAKER HUGHES INCORPORATED, Houston, TX (US)

(21) Appl. No.: 13/197,229

(22) Filed: Aug. 3, 2011

(51) Int. Cl. G01V 3/26; G06F 19/00

(52) U.S. Cl. 702/7

(57) ABSTRACT

An apparatus and method for estimating a resistivity property of an earth formation involving electric current induced in an earth formation. The method may include reducing an error in a voltage received by a receiver coil due to excitation of a transmitter coil due to temperature effects. The voltage may include amplitude and/or phase errors. The method may modify the measured voltage by multiplying/dividing the voltage by a reduction factor. The reduction factor may be determined using polynomic curve fitting. The apparatus may be configured to perform the method. The apparatus may include at least one transmitter coil, at least one receiver coil, and at least one processes configured to perform the error reduction.

### FIELD OF THE DISCLOSURE

This disclosure generally relates to exploration for hydrocarbons involving electrical investigations of a borehole penetrating an earth formation. More specifically, this disclosure relates to improved estimates of resistivity properties during borehole investigations. For the purposes of the present disclosure, the term “resistivity property” includes conductivity and dielectric constant.

### BACKGROUND OF THE DISCLOSURE

Electrical earth borehole logging is well known and various devices and various techniques have been described for this purpose. Broadly speaking, there are two categories of devices used in electrical logging devices. In the first category, a transmitter (such as a guard electrode) is uses in conjunction with a diffuse return electrode (such as the tool body). A measured electric current flows in a circuit that connects a voltage source to the transmitter, through the earth formation to the return electrode and back to the voltage source in the tool. A second or center electrode is fully or at least partially surrounded by said guard electrode. Provided both electrodes are kept at the same potential, a current flowing through the center electrode is focused into the earth formation by means of the guard electrode. Generally, the center electrode current is several orders of magnitude smaller than the guard current.

The second category includes inductive measuring tools, such as when an antenna within the measuring instrument induces a current flow within the earth formation. The magnitude of the induced current is detected using either the same antenna or a separate receiver antenna. The present disclosure belongs to the second category.

The induced current detected by the separate receiver may be converted into a voltage indicative of a resistivity property of the earth formation. The temperature of the earth formation and/or borehole may alter the voltage generated by the receiver, particularly when the receiver is coupled to a thermally conductive structure, such as a drill string. This disclosure addresses these temperature effects.

### SUMMARY OF THE DISCLOSURE

In aspects, the present disclosure is related to methods and apparatuses for reducing measurement error due to temperature effects while conducting borehole investigations to estimate resistivity properties of an earth formation.

One embodiment according to the present disclosure may include a method of estimating at least one resistivity property of an earth formation, comprising: estimating the at least one resistivity property based on information obtained by a logging tool conveyed in a borehole penetrating the earth formation, the logging tool comprising at least one transmitter coil and at least one receiver coil, wherein the information includes an error reduction for temperature effects that is independent of a distance between the at least one transmitter coil and the at least one receiver coil.

Another embodiment according to the present disclosure may include an apparatus for estimating at least one resistivity property of an earth formation, comprising: a housing configured to be conveyed in a borehole; at least one transmitter coil disposed on the housing and configured to transmit an electric current into the earth formation; at least one receiver coil configured to generate information in response to the electric current; and at least one processor configured to: reduce an error in the information due to temperature effects independent of a distance between the at least one transmitter coil and the at least one receiver coil, and estimate at least one resistivity property based on the information after error reduction.

Another embodiment according to the present disclosure may include a non-transitory computer-readable medium product having instructions thereon that, when executed, cause at least one processor to perform a method, the method comprising: estimating at least one resistivity property of an earth formation based on information obtained by a logging tool conveyed in a borehole penetrating the earth formation, the logging tool comprising at least one transmitter coil and at least one receiver coil, wherein the information includes an error reduction for temperature effects that is independent of a distance between the at least one transmitter coil and the at least one receiver coil.

Examples of the more important features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of an azimuthal resistivity tool deployed in a wellbore along a drill string according to one embodiment of the present disclosure;

FIG. 2 shows a schematic close up of an azimuthal resistivity tool configured for deployment in a wellbore according to one embodiment of the present disclosure;

FIG. 3 shows a flow chart of a method for estimating a resistivity property using an azimuthal resistivity tool and reducing an error according to one embodiment of the present disclosure;

FIG. 4 graphically illustrates voltage amplitudes in receiver coils due to excitation of transmitters coils varying with temperature according to one embodiment of the present disclosure;

FIG. 5 graphically illustrates phase differences between transmitter and receiver coils varying with temperature according to one embodiment of the present disclosure;

FIG. 6 graphically illustrates polynomic curve fitting for reducing an amplitude error according to one embodiment of the present disclosure;

FIG. 7 graphically illustrates voltage amplitudes in receiver coils due to excitation of transmitter coils varying with temperature after error reduction according to one embodiment of the present disclosure;

FIG. 8 graphically illustrates polynomic curve fitting for reducing a phase error according to one embodiment of the present disclosure; and

FIG. 9 graphically illustrates phase differences between transmitter and receiver coils varying with temperature after error reduction according to one embodiment of the present disclosure.

### DETAILED DESCRIPTION

This disclosure generally relates to exploration for hydrocarbons involving electrical investigations of a borehole penetrating an earth formation. More specifically, this disclosure relates to reducing measurement error due to temperature effects while conducting borehole investigations.

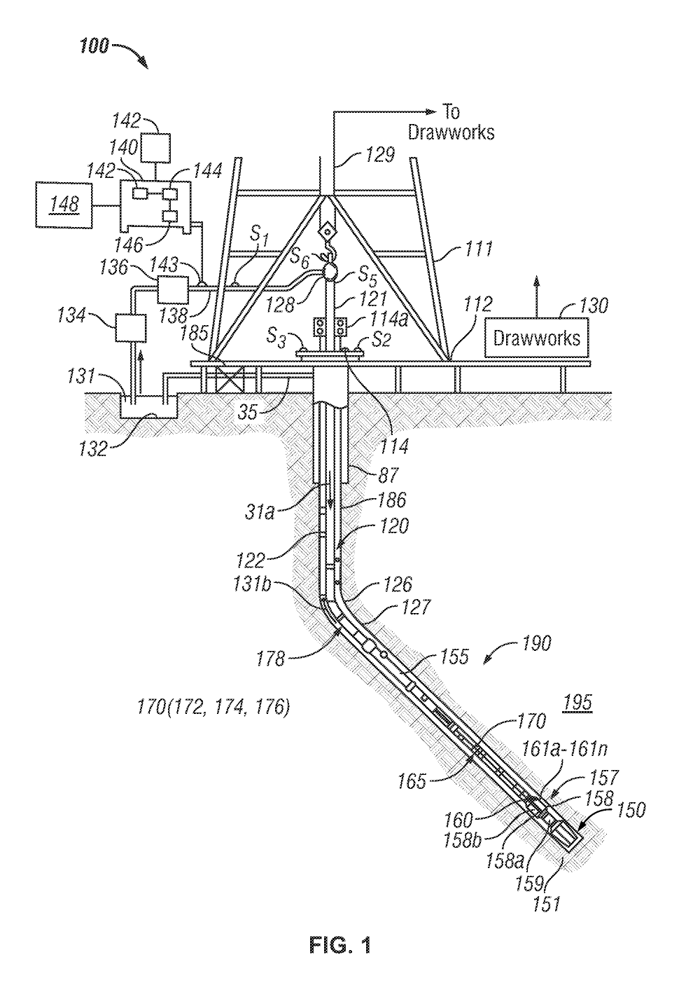

FIG. 1 is a schematic diagram of an exemplary drilling system 100 that includes a drill string having a drilling assembly attached to its bottom end that includes a steering unit according to one embodiment of the disclosure. FIG. 1 shows a drill string 120 that includes a drilling assembly or bottomhole assembly (BHA) 190 conveyed in a borehole 126. The drilling system 100 includes a conventional derrick 111 erected on a platform or floor 112 which supports a rotary table 114 that is rotated by a prime mover, such as an electric motor (not shown), at a desired rotational speed. A tubing (such as jointed drill pipe) 122, having the drilling assembly 190, attached at its bottom end extends from the surface to the bottom 151 of the borehole 126. A drill bit 150, attached to drilling assembly 190, disintegrates the geological formations when it is rotated to drill the borehole 26. The drill string 120 is coupled to a drawworks 130 via a Kelly joint 121, swivel 128 and line 129 through a pulley. Drawworks 130 is operated to control the weight on bit (“WOB”). The drill string 120 may be rotated by a top drive (not shown) instead of by the prime mover and the rotary table 114. Alternatively, a coiled-tubing may be used as the tubing 122. A tubing injector 114a may be used to convey the coiled-tubing having the drilling assembly attached to its bottom end. The operations of the drawworks 130 and the tubing injector 114a are known in the art and are thus not described in detail herein.

A suitable drilling fluid 131 (also referred to as the “mud”) from a source 132 thereof, such as a mud pit, is circulated under pressure through the drill string 120 by a mud pump 134. The drilling fluid 131 passes from the mud pump 134 into the drill string 120 via a desurger 136 and the fluid line 138. The drilling fluid 131a from the drilling tubular discharges at the borehole bottom 151 through openings in the drill bit 150. The returning drilling fluid 131b circulates uphole through the annular space 127 between the drill string 120 and the borehole 126 and returns to the mud pit 132 via a return line 135 and drill cutting screen 185 that removes the drill cuttings 186 from the returning drilling fluid 131b. A sensor S₁ in line 138 provides information about the fluid flow rate. A surface torque sensor S₂ and a sensor S₃ associated with the drill string 120 respectively provide information about the torque and the rotational speed of the drill string 120. Tubing injection speed is determined from the sensor S₅, while the sensor S₆ provides the hook load of the drill string 120.

In some applications, the drill bit 150 is rotated by only rotating the drill pipe 122. However, in many other applications, a downhole motor 155 (mud motor) disposed in the drilling assembly 190 also rotates the drill bit 150. The rate of penetration for a given BHA largely depends on the WOB or the thrust force on the drill bit 150 and its rotational speed.

The mud motor 155 is coupled to the drill bit 150 via a drive shaft disposed in a bearing assembly 157. The mud motor 155 rotates the drill bit 150 when the drilling fluid 131 passes through the mud motor 155 under pressure. The bearing assembly 157, in one aspect, supports the radial and axial forces of the drill bit 150, the down-thrust of the mud motor 155 and the reactive upward loading from the applied weight-on-bit.

A surface control unit or controller 140 receives signals from the downhole sensors and devices via a sensor 143 placed in the fluid line 138 and signals from sensors S₁-S₆ and other sensors used in the system 100 and processes such signals according to programmed instructions provided to the surface control unit 140. The surface control unit 140 displays desired drilling parameters and other information on a display/monitor 142 that is utilized by an operator to control the drilling operations. The surface control unit 140 may be a computer-based unit that may include a processor 142 (such as a microprocessor), a storage device 144, such as a solid-state memory, tape or hard disc, and one or more computer programs 146 in the storage device 144 that are accessible to the processor 142 for executing instructions contained in such programs. The surface control unit 140 may further communicate with a remote control unit 148. The surface control unit 140 may process data relating to the drilling operations, data from the sensors and devices on the surface, data received from downhole, and may control one or more operations of the downhole and surface devices. The data may be transmitted in analog or digital form.

The BHA may also contain formation evaluation sensors or devices (also referred to as measurement-while-drilling (“MWD”) or logging-while-drilling (“LWD”) sensors) determining resistivity, density, porosity, permeability, acoustic properties, nuclear-magnetic resonance properties, formation pressures, properties or characteristics of the fluids downhole and other desired properties of the earth formation 195 surrounding the drilling assembly 190. Such sensors are generally known in the art and for convenience are generally denoted herein by numeral 165. The drilling assembly 190 may further include a variety of other sensors and devices 159 for determining one or more properties of the BHA (such as vibration, bending moment, acceleration, oscillations, whirl, stick-slip, etc.) and drilling operating parameters, such as weight-on-bit, fluid flow rate, pressure, temperature, rate of penetration, azimuth, tool face, drill bit rotation, etc.) For convenience, all such sensors are denoted by numeral 159.

The drilling assembly 190 includes a steering apparatus or tool 158 for steering the drill bit 150 along a desired drilling path. In one aspect, the steering apparatus may include a steering unit 160, having a number of force application members 161a-161n, wherein the steering unit is at partially integrated into the drilling motor. In another embodiment the steering apparatus may include a steering unit 158 having a bent sub and a first steering device 158a to orient the bent sub in the wellbore and the second steering device 158b to maintain the bent sub along a selected drilling direction.

The MWD system may include sensors, circuitry and processing software and algorithms for providing information about desired dynamic drilling parameters relating to the BHA, drill string, the drill bit and downhole equipment such as a drilling motor, steering unit, thrusters, etc. Exemplary sensors include, but are not limited to, drill bit sensors, an RPM sensor, a weight on bit sensor, sensors for measuring mud motor parameters (e.g., mud motor stator temperature, differential pressure across a mud motor, and fluid flow rate through a mud motor), and sensors for measuring acceleration, vibration, whirl, radial displacement, stick-slip, torque, shock, vibration, strain, stress, bending moment, bit bounce, axial thrust, friction, backward rotation, BHA buckling and radial thrust. Sensors distributed along the drill string can measure physical quantities such as drill string acceleration and strain, internal pressures in the drill string bore, external pressure in the annulus, vibration, temperature, electrical and magnetic field intensities inside the drill string, bore of the drill string, etc. Suitable systems for making dynamic downhole measurements include COPILOT, a downhole measurement system, manufactured by BAKER HUGHES INCORPORATED. Suitable systems are also discussed in “Downhole Diagnosis of Drilling Dynamics Data Provides New Level Drilling Process Control to Driller”, SPE 49206, by G. Heisig and J. D. Macpherson, 1998.

The MWD system 100 can include one or more downhole processors at a suitable location such as 193 on the BHA 190. The processor(s) can be a microprocessor that uses a computer program implemented on a suitable machine readable medium that enables the processor to perform the control and processing. The machine readable medium may include ROMs, EPROMs, EAROMs, EEPROMs, Flash Memories, RAMs, Hard Drives and/or Optical disks. Other equipment such as power and data buses, power supplies, and the like will be apparent to one skilled in the art. In one embodiment, the MWD system utilizes mud pulse telemetry to communicate data from a downhole location to the surface while drilling operations take place. The surface processor 142 can process the surface measured data, along with the data transmitted from the downhole processor, to evaluate formation lithology. The sensors 165 may include a resistivity tool 170.

While a drill string 120 is shown as a conveyance system for sensors 165, it should be understood that embodiments of the present disclosure may be used in connection with tools conveyed via rigid (e.g. jointed tubular or coiled tubing) as well as non-rigid (e.g. wireline, slickline, e-line, etc.) conveyance systems. A downhole assembly (not shown) may include a bottomhole assembly and/or sensors and equipment for implementation of embodiments of the present disclosure on either a drill string or a wireline.

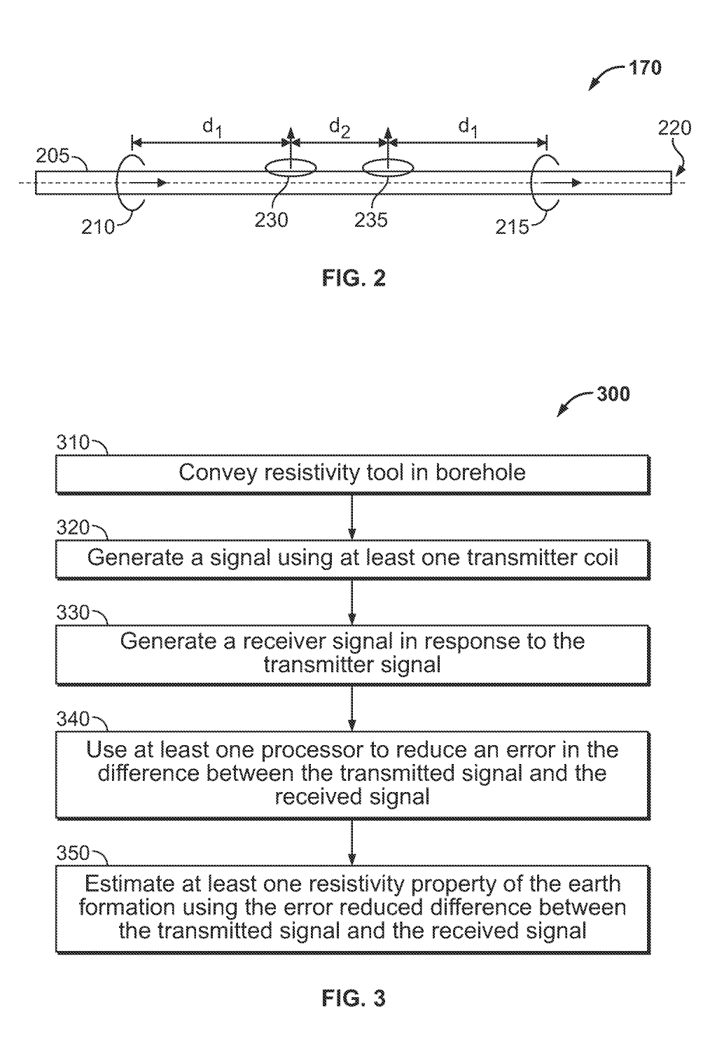

FIG. 2 shows an embodiment of an azimuthal resistivity tool 170 suitable for use with the present disclosure. Resistivity tool 170 may include a housing 205, two transmitter coils 210, 215 whose dipole moments are parallel to the tool axis direction 220, and two receiver coils 230, 235 that are perpendicular to the transmitter direction. In another embodiment, the transmitter coils may have dipole moments that are perpendicular to the tool axis direction. Housing 205 may be part of or independent of drill string 120. The transmitter coils 210, 215 may be separated from corresponding receiver coils 230, 235 by distance d₁. Receiver coil 230 may be separated from receiver coil 235 by distance d₂. In one embodiment of the present disclosure, the tool 170 may operate at 400 kHz frequency. When the first transmitter coil 210 fires, the two receiver coils 230, 235 measure the magnetic field produced by the induced current in the formation. This is repeated for, the second transmitter coil 215. The signals may be combined in following way:

H_{T1}=H₂−(d₁/(d₁+d₂)³·H₁

H_{T2}=H₁−(d₁/(d₁+d₂))³·H₂ (1).

Here, H₁ and H₂ are the measurements from the first and second receiver coils 230, 235, respectively, and the distances d₁ and d₂. The tool rotates with the BHA and, in an exemplary mode of operation, makes continuous measurements that may be averaged into 16 angular orientations that are 22.5° apart. The measurement registration point is at the center of two receiver coils 230, 235. In a uniform, isotropic formation, no signal would be detected at either of the two receiver coils 230, 235. The disclosure thus may make use of cross component measurements, called principal cross-components, obtained from a pair of transmitter coils disposed on either side of at least one receiver coil. It should further be noted that using well known rotation of coordinates, the method of the present disclosure also works with various combinations of measurements as long as they (i) correspond to signals generated from opposite sides of a receiver, and, (ii) can be rotated to give the principal cross components.

FIG. 3 shows an exemplary method 300 according to one embodiment of the present disclosure. In method 300, an azimuthal resistivity tool 170 may be conveyed in a borehole. The azimuthal resistivity tool 170 may be configured for, but not limited to, conveyance in a borehole 126 on one of: (i) a wireline and (ii) a drill string 120. In step 320, at least one transmitter coil 210, 215 may generate a signal. In step 330, at least one receiver coil 230, 235 may generate a signal responsive to the transmitted signal. In step 340, at least one processor may reduce an error in a difference between the transmitted signal and the received signal using information about temperature effects due to the earth formation 195. The error reduction may be independent of a distance between the at least one transmitter coil 210, 215 and the at least one receiver coil 230, 235. In step 350, a resistivity property may be estimated by the at least one processor using the signal difference after error reduction.

The error reduction in step 340 may include reducing one or more of: (i) a voltage amplitude error and (ii) a phase error. The error reduction may include a polynomic function, such as a quadratic function. The error reduction may include multiplying/dividing a voltage and/or phase by an correction factor α. For example, a corrected voltage amplitude Vc may be expressed as:

$${V}_{c} = \frac{{V}_{m}}{α} ,$$

where Vₘ is the measured voltage amplitude received at a receiver coil due to excitation of a transmitter coil, and cc may be obtained using the equation:

α=a(T−25)²+b(T−25)+c,

where T is temperature and a, b, and c are curve fitting coefficients.

In some embodiments, step 340 may include a phase error reduction. The phase may be offset by fitting the phase measurements with an offset ΔP such that:

ΔP=e(T−25)²+f(T−25),

where e and f are curve fitting coefficients.

Thus, the final phase P_{f} may be expressed as:

P_{f}=Pₘ+P_{c}+Pₑ−ΔP,

where Pₘ is the measured phase, P_{c} a phase calibration offset, and Pₑ is a phase shift due to electronics.

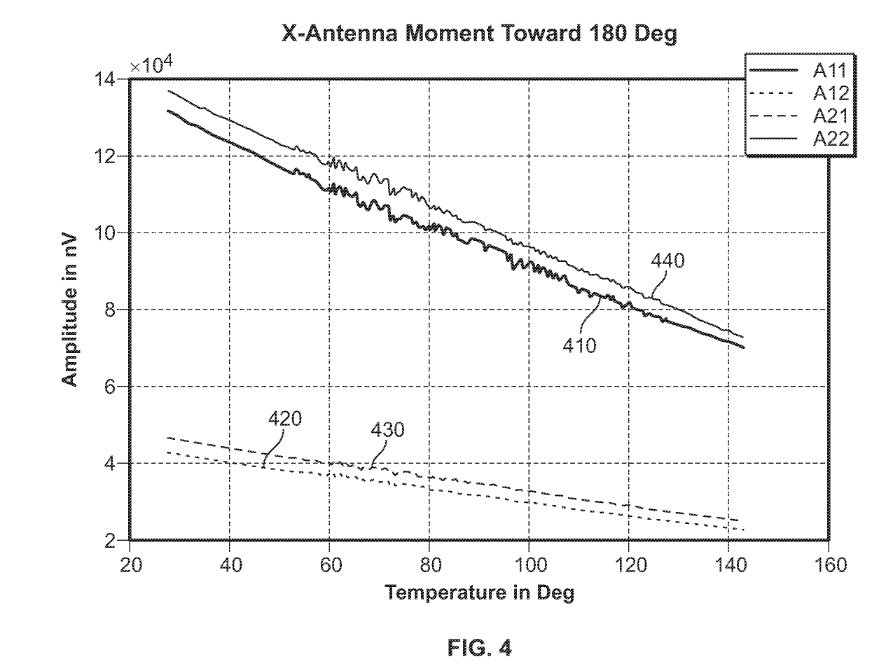

FIG. 4 shows a graph with a set of curves representing the voltage amplitude received at a receiver 230, 235 due to excitation of a transmitter 210, 215 varying with temperature. Curve 410 represents the voltage amplitude received at receiver 230 due to excitation of transmitter 210 for different temperatures. Curves 420, 430, 440 represent the corresponding voltage amplitudes received at receiver 235 due to excitation of transmitter 210, receiver 230 due to excitation of transmitter 215, and receiver 235 due to excitation of transmitter 215 for different temperatures.

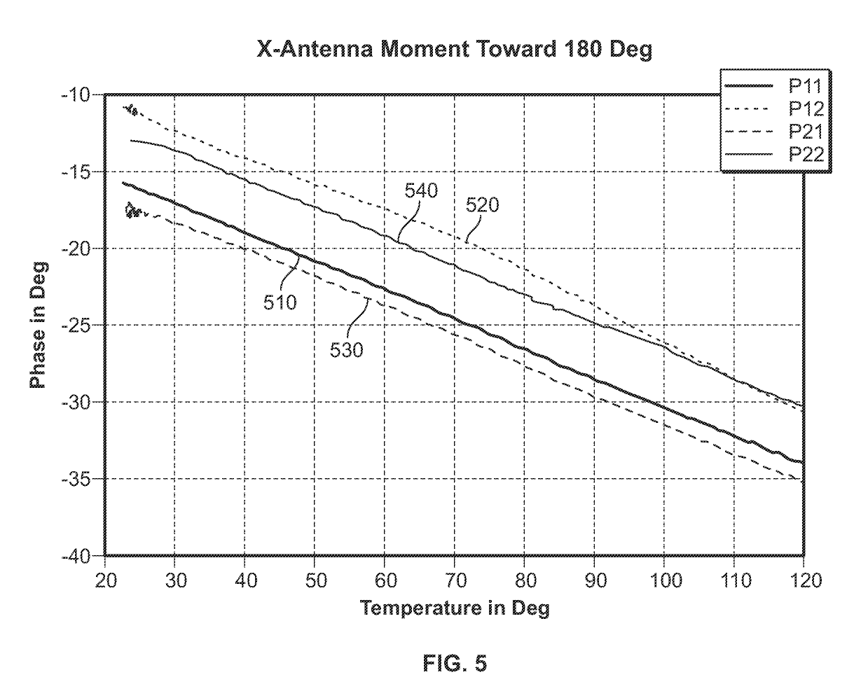

FIG. 5 shows a graph with a set of curves representing the phase difference varying with temperature between a transmitter 210, 215 and a receiver 230, 235. Curve 510 represents the phase difference between transmitter 210 and receiver 230 for different temperatures. Curves 520, 530, 540 represent the corresponding phase differences between transmitter 210 and receiver 235, transmitter 215 and receiver 230, and transmitter 215 and receiver 235 for different temperatures.

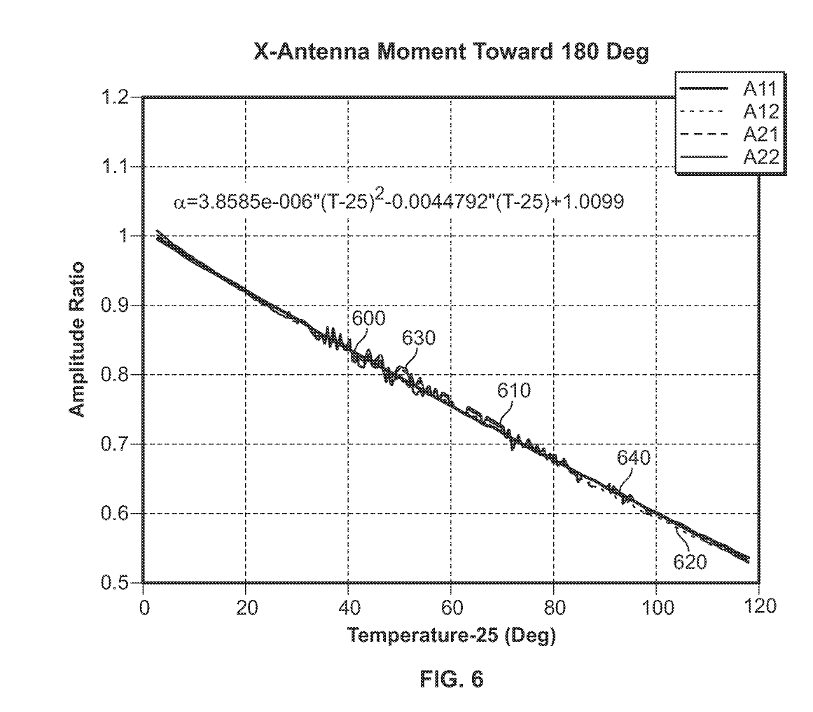

FIG. 6 shows a graph with a set of curves from FIG. 4 after normalization of amplitudes with a quadratic fitting function 600. Curves 610, 620, 630, 640 are normalized curves from curves 410, 420, 430, 440.

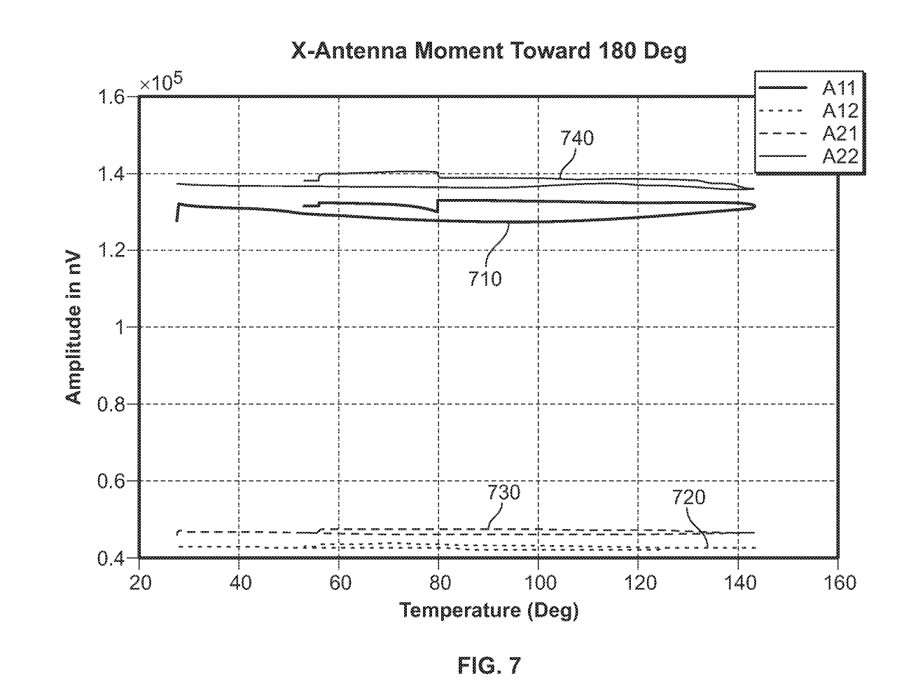

FIG. 7 shows a graph with a set of curves representing the voltage amplitude received at a receiver 230, 235 due to excitation of a transmitter 210, 215 varying with temperature after correction for temperature. Curve 710 represents the voltage amplitude received at receiver 230 due to excitation of transmitter 210 for different temperatures after correction. Curves 720, 730, 740 represent the corresponding voltage amplitudes received at receiver 235 due to excitation of transmitter 210, receiver 230 due to excitation of transmitter 215, and receiver 235 due to excitation of transmitter 215 for different temperatures after correction.

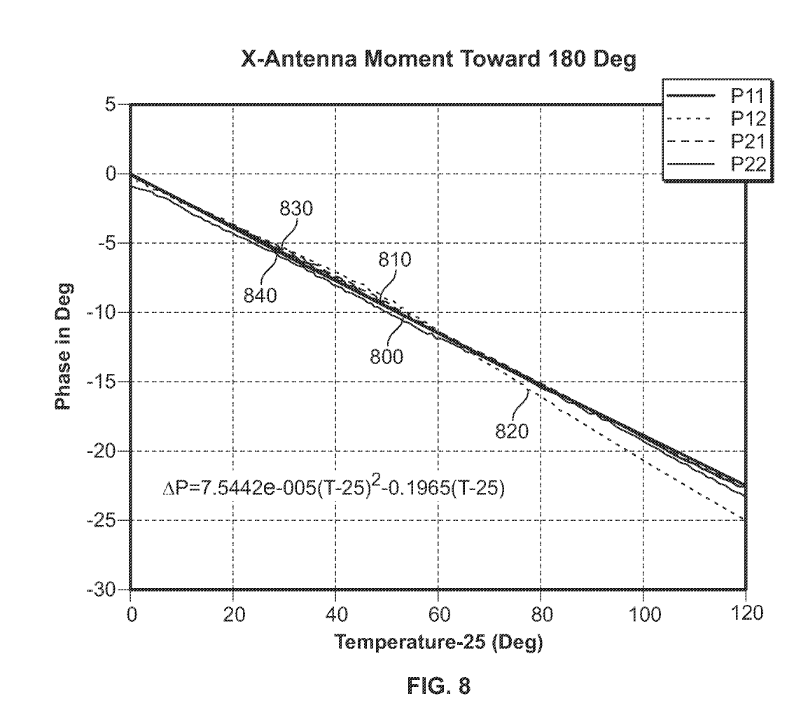

FIG. 8 shows a graph with a set of curves from FIG. 5 after offset correction of phase with a quadratic fitting function 800. Curves 810, 820, 830, 840 are normalized curves from curves 510, 520, 530, 540.

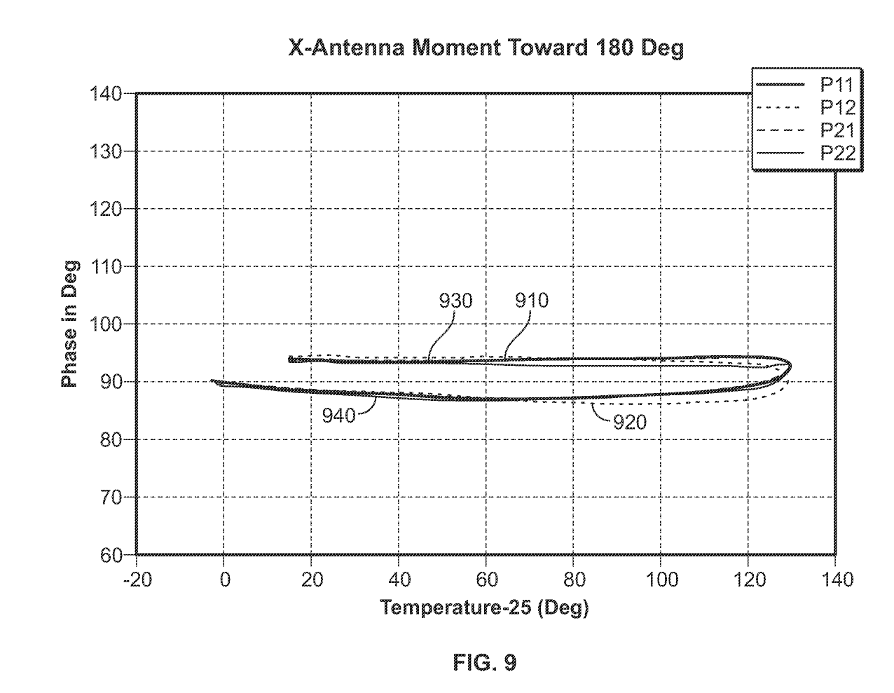

FIG. 9 shows a graph with a set of curves representing the phase difference varying with temperature between a transmitter 210, 215 and a receiver 230, 235 after correction. Curve 910 represents the phase difference between transmitter 210 and receiver 230 for different temperatures after correction. Curves 920, 930, 940 represent the corresponding phase differences between transmitter 210 and receiver 235, transmitter 215 and receiver 230, and transmitter 215 and receiver 235 for different temperatures after correction.

Implicit in the processing of the data is the use of a computer program implemented on a suitable machine readable medium that enables the processor to perform the control and processing. The term processor as used in this application is intended to include such devices as field programmable gate arrays (FPGAs). The machine readable medium may include ROMs, EPROMs, EAROMs, Flash Memories and Optical disks. As noted above, the processing may be done downhole or at the surface, by using one or more processors. In addition, results of the processing, such as an image of a resistivity property, can be stored on a suitable medium.

While the foregoing disclosure is directed to the one mode embodiments of the disclosure, various modifications will be apparent to those skilled in the art. It is intended that all variations be embraced by the foregoing disclosure.

What is claimed is:

1. A method of estimating at least one resistivity property of an earth formation, comprising:
estimating the at least one resistivity property based on information obtained by a logging tool conveyed in a borehole penetrating the earth formation, the logging tool comprising at least one transmitter coil and at least one receiver coil, wherein the information includes an error reduction for temperature effects that is independent of a distance between the at least one transmitter coil and the at least one receiver coil.

2. The method of claim 1, further comprising:
reducing the error in the information due to temperature effects.

3. The method of claim 1, further comprising:
conveying the logging tool in the borehole.

4. The method of claim 1, wherein the error reduction is based on a curve fitting.

5. The method of claim 4, wherein the curve fitting uses a quadratic function.

6. The method of claim 1, wherein the information includes at least one of: (i) a voltage amplitude and (ii) a phase angle.

7. The method of claim 1, wherein the logging tool includes a receiver coil configured to generate the information in response to an induced current.

8. The method of claim 1, wherein the logging tool is configured for at least one of: (i) wireline measurement and (ii) measurement-while-drilling.

9. An apparatus for estimating at least one resistivity property of an earth formation, comprising:
a housing configured to be conveyed in a borehole;
at least one transmitter coil disposed on the housing and configured to transmit an electric current into the earth formation;
at least one receiver coil configured to generate information in response to the electric current; and
at least one processor configured to:
reduce an error in the information due to temperature effects independent of a distance between the at least one transmitter coil and the at least one receiver coil, and
estimate at least one resistivity property based on the information after error reduction.

10. The apparatus of claim 9, wherein the error reduction is based on a curve fitting.

11. The apparatus of claim 10, wherein the curve fitting uses a quadratic function.

12. The apparatus of claim 9, wherein the information includes at least one of: (i) a voltage amplitude and (ii) a phase angle.

13. The apparatus of claim 9, wherein the housing is configured to be conveyed in the borehole on one of: (i) a wireline and (ii) a bottom hole assembly on a drilling tubular.

14. A non-transitory computer-readable medium product having instructions thereon that, when executed, cause at least one processor to perform a method, the method comprising:
estimating at least one resistivity property of an earth formation based on information obtained by a logging tool conveyed in a borehole penetrating the earth formation, the logging tool comprising at least one transmitter coil and at least one receiver coil, wherein the information includes an error reduction for temperature effects that is independent of a distance between the at least one transmitter coil and the at least one receiver coil.

15. The computer-readable medium product of claim 14 further comprising at least one of: (i) a ROM, (ii) an EPROM, (iii) an EEPROM, (iv) a flash memory, or (v) an optical disk.
